(19) United States
(12) Patent Application Publication
(10) Pub. No.: US 2009/0308548 A1
(43) Pub. Date: Dec. 17, 2009

(54) Temporary partition curtain

(76) Inventors: Paul F. Tramontina, Harleysville, PA (US); Jeffrey J. Krueger, Roswell, GA (US); Jackie B. Martin, Buford, GA (US); Frances Mayfield, Marietta, GA (US); Ann Louise McCormack, Cumming, GA (US)

Correspondence Address: KIMBERLY-CLARK WORLDWIDE, INC.;Catherine E. Wolf, 401 NORTH LAKE STREET, NEENAH, WI, 54956, US

(21) Appl. No.: 12/214,036

(22) Filed: Jun. 16, 2008

(51) Int. Cl. B01D 39/08; A47H 33/00

(52) U.S. Cl. 160/405; 55/522

(57) ABSTRACT

A temporary partition curtain for isolating a first area from a second area is disclosed. The temporary partition curtain is prepared from a nonwoven sheet material having a first side and a second side, the nonwoven sheet material has an air permeability of at least about 10 ft³/min/ft². In addition, the nonwoven sheet material substantially prevents particles from passing through the nonwoven sheet material from the first side to the second side; thereby substantially preventing particles from passing from the first area to the second area. Also disclosed is a method of isolating a first area from a second area using the temporary partition curtain.

### FIELD OF THE INVENTION

The present invention relates generally to the field of temporary partition curtains, and more particularly to a temporary partition curtain that utilizes a breathable material as the partition.

### BACKGROUND OF THE INVENTION

Control of dust and other airborne particulates material including particles and fibers is a major issue in building construction and renovation projects, particularly when other sections of the building or structure are not under construction and/or are inhabited or otherwise used. Generally, it is very desirable that the other inhabited sections remain free of such dust and airborne particulates. The effects of high concentrations of airborne dust and other particulates on personnel and equipment are well known, and must be minimized. High concentration of dust and other airborne particulates has been known to cause illness in personnel. In addition, electronic equipment (e.g., computer equipment, electronic control systems, HVAC systems, and the like) are also adversely affected by high levels of airborne particulates and must be protected from excess exposure to dust and other matter generated from construction and remodeling projects.

Current methods of airborne dust and particulate control involve erecting portable partitions to isolate the areas where dust is being produced. These partitions generally use any number of portable scaffolding, poles, or other structure for supporting plastic sheeting or other generally air and/or liquid impermeable sheeting materials between the floor and ceiling to create an isolated area. That is, the isolated area is a “dirty” or particulate/dust generating area which is to be isolated from the area to remain clean. Theses conventional sheeting materials are, however, problematic in certain respects. For example, plastic sheeting materials are non-porous and do not allow air to circulate into or out of the isolated area. The isolated area may eventually become hot and humid, since the plastic sheeting does not effectively allow air to effectively circulate. This may result in a less than optimal working environment for personnel that must work within the isolated area.

While plastic sheeting may be effective in essentially trapping the dust or other airborne particulates generated within the isolated area, plastic sheeting has other drawbacks. For example, plastic sheeting material does not effectively capture and hold the airborne particulates. While airborne particulates may attach to plastic sheeting, as the plastic sheeting is moved or disturbed in the place of use, for example by personnel entering or exiting the isolated work area or a pressure differential created by an opening or closing of a door or window near the partitioned area, these particulates are generally caused to be released from the plastic sheeting, causing the particulates to become airborne again within the isolated area. This often results in the particulates accumulating on the floor of the isolated area or outside the isolated area near the entrance created to the isolated area. It is generally undesirable to have the particles reenter the air in the isolated area, since this will reduce the air quality in the isolated area.

There is a need in the art for a temporary partition curtain which will effectively capture and hold airborne particulates and effectively prevents the airborne particles from escaping the isolated area. There is also a need in the art for a temporary partition curtain made from a material which is breathable, allowing air to be exchanged from the isolated area with the surrounding area, without having airborne particulates migrate from the isolated area to the surrounding area.

### SUMMARY OF THE INVENTION

The present invention provides a temporary dust partition curtain which may be used to effectively isolate a first area from a second area. The temporary partition curtain is prepared from a nonwoven sheet material having a first side and a second side. The nonwoven sheet material has an air permeability of at least about 10 ft³/min/ft² as measured by ISO-9237 (1995) at a test pressure of 125 Pa. In addition, the nonwoven sheet material substantially prevents airborne particulates from passing through the nonwoven sheet material from the first side of the sheet material to the second side of the sheet material. The nonwoven sheet material, when placed between the first area and the second area, substantially prevents airborne particulates present in the first area from migrating to the second area.

The present invention also provides a method of isolating a first area from a second area to substantially prevent airborne particulates present in the first area from migrating from the first area to the second area. The method includes providing a nonwoven sheet material having a first side and a second side, wherein the nonwoven sheet material has an air permeability of at least about 10 ft³/min/ft² as measured by ISO-9237 (1995) at a test pressure of 125 Pa. The nonwoven sheet material substantially prevents airborne particulates from passing through the nonwoven sheet material from the first side to the second side. In addition, the method includes placing the nonwoven sheet material between the first area and the second area and sealing the first area from the second area using the nonwoven sheet material.

In a further embodiment of the present invention, the nonwoven sheet material of the temporary partition curtain and method of isolating a first area from a second area has an air permeability of between about 25 ft³/min/ft² and about 600 ft³/min/ft² as measured by ISO-9237 (1995) at a test pressure of 125 Pa. In an additional embodiment, the nonwoven has an air permeability of between about 200 ft³/min/ft² and about 400 ft³/min/ft² as measured by ISO-9237 (1995) at a test pressure of 125 Pa.

Suitable nonwoven sheet material which may be used for the temporary partition curtain and the method of isolating a first area from a second area may be prepared from a spunbond nonwoven web, a meltblown nonwoven web, a bonded carded nonwoven web, or a laminate thereof. Suitable laminates may also include laminates of permeable materials, including nonwoven materials laminated to air permeable materials, such as apertured films and other nonwoven materials. In one particular embodiment, the nonwoven sheet material is a spunbond/meltblown/spunbond (SMS) laminate.

In a further embodiment, the nonwoven sheet material may be electret treated. Electret treatment improves the ability of the nonwoven sheet material to capture and hold the particles generated in the first area from escaping to the first area to the second area.

### BRIEF DESCRIPTION OF THE DRAWINGS

FIG. 1 shows a chart of particle size of various particles which may be present within buildings.

FIG. 2 shows a diagram of the test equipment used to determine the gravimetric fractional efficiency.

### DETAILED DESCRIPTION

The present invention provides a temporary partition curtain which may be used to effectively isolate a first area from a second area. The temporary partition curtain is prepared from a nonwoven sheet material. The nonwoven sheet material, when placed between the first area and the second area, substantially prevents airborne particulates present in the first area from migrating to the second area. As used herein, the term “airborne particulates” is intended to mean particles, fibers and other matter that may become airborne within a home or place of business as a result of construction. As described herein, for purposes of discussion and understanding the invention, the “first area” is generally the area which is to be isolated by the temporary partition curtain. The first area is generally the area in which the dust or particles, which are to be kept from the second area, are generated. Stated another way, as described in the specification, the first area is the “dirty” area and the second area is the “clean” area. It is noted, however, that the first area does not need to have particles generated therein. The first area may be an area which is not to be disturbed, such as an area which has been recently painted or may be an area which is desired not to be viewed with ease. For the purposes of the present invention, it is not necessary that airborne particulates be generated in the first area; however, the first area is area which is to be isolated.

As used herein, the term “substantially prevents” is intended to mean that a majority of the particles which are generated or present in the first area are maintained in the first area. That is, the nonwoven sheet material retains more particles within the first area than pass through the nonwoven material to the second area. To determine if a nonwoven sheet material substantially prevents particles from passing through the material, the material may be tested using the Gravimetric Fractional Efficiency Test described herein.

The nonwoven sheet materials maybe a variety of nonwoven webs known to those skilled in the art. As used herein the terms “nonwoven sheet material” and nonwoven web” mean a web having a structure of individual fibers or threads which are interlaid, but not in an identifiable manner as in a knitted fabric. Nonwoven sheet materials are sometimes referred to as nonwoven fabrics. For instance, nonwoven fabrics or webs have been formed from many processes such as, for example, meltblowing processes, spunbonding processes, bonded carded web processes, air-laying process, and hydroentangling process. Nonwovens may also be laminates of one or more of these nonwoven fabrics or webs.

Spunbond nonwoven webs are prepared from spunbond fibers. As used herein the terms “spunbonded fibers” and “spunbond fibers” refer to small diameter fibers which are formed by extruding molten thermoplastic material as filaments from a plurality of fine, usually circular capillaries of a spinneret with the diameter of the extruded filaments then being rapidly reduced as by, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, and U.S. Pat. No. 3,542,615 to Dobo et al. Spunbond fibers are generally not tacky when they are deposited onto a collecting surface. Spunbond fibers are generally continuous and have average diameters (using a sample size of at least 10) larger than 7 microns, more particularly, between about 10 and 25 microns.

Meltblown nonwoven webs are prepared from meltblown fibers. As used herein the term “meltblown fibers” means fibers formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Buntin. Meltblown fibers are microfibers which may be continuous or discontinuous, are generally smaller than 10 microns in average diameter (using a sample size of at least 10), and are generally tacky when deposited onto a collecting surface.

“Bonded carded web” refers to webs that are made from staple fibers which are sent through a combing or carding unit, which separates or breaks apart and aligns the staple fibers in the machine direction to form a generally machine direction-oriented fibrous nonwoven web. Such fibers are usually purchased in bales which are placed in an opener/blender or picker which separates the fibers prior to the carding unit. Once the web is formed, it then is bonded by one or more of several known bonding methods. One such bonding method is powder bonding, wherein a powdered adhesive is distributed through the web and then activated, usually by heating the web and adhesive with hot air. Another suitable bonding method is pattern bonding, wherein heated calender rolls or ultrasonic bonding equipment are used to bond the fibers together, usually in a localized bond pattern, though the web can be bonded across its entire surface if so desired. Another suitable and well-known bonding method, particularly when using bicomponent staple fibers, is through-air bonding.

“Airlaying” or “airlaid” is a well known process by which a fibrous nonwoven layer can be formed. In the airlaying process, bundles of small fibers having typical lengths ranging from about 3 to about 19 millimeters (mm) are separated and entrained in an air supply and then deposited onto a forming screen, usually with the assistance of a vacuum supply. The randomly deposited fibers then are bonded to one another using, for example, hot air or a spray adhesive.

Hydroentangled webs, which are also known as “spunlace” webs, refer to webs prepared by a process which subjects the web to columnar jets of a fluid that cause the fibers in the web to entangle. Hydroentangling a web typically increases the strength of the web. Thus, according to the present invention, in order to increase the strength of a web, the base web of the present invention can be hydroentangled. For example, in one embodiment, the base web can comprise HYDROKNIT®, a nonwoven composite fabric that contains 70% by weight pulp fibers that are hydraulically entangled into a continuous filament material. HYDROKNIT® material is commercially available from Kimberly-Clark Corporation of Neenah, Wis. Hydraulic entangling may be accomplished utilizing conventional hydraulic entangling equipment such as may be found in, for example, in U.S. Pat. No. 3,485,706 to Evans or U.S. Pat. No. 5,389,202 to Everhart et al., the disclosures of which are hereby incorporated by reference.

Generally, the nonwoven sheet material should be selected such that the nonwoven sheet material is durable, fairly lightweight, air permeable and has the ability to substantially prevent particles from passing through the nonwoven sheet material. Another consideration is the nonwoven sheet materials should also be a fairly low cost material, given the temporary nature of the temporary partition curtain. The nonwoven web material should be durable in that it is not damaged during installation of the temporary partition curtains and should not be damaged or otherwise compromised during use, including entry and exit of personnel into the first area or area of work being performed. Generally, the nonwoven sheet material should be abrasion resistant, puncture resistant and should resist tearing during use. In addition, the nonwoven sheet material should have relatively low drape stiffness. Drape stiffness may be measured under ASTM Standard Test D-1388-07a, which is hereby incorporated by reference.

The nonwoven sheet material should be a relatively lightweight material. The basis weight, which is a measurement of weight of the nonwoven sheet material per unit area, is usually expressed in ounces per square yard (osy) or grams per square meter (gsm) and the fiber diameters useful in the present are usually expressed in microns, or in the case of staple fibers, denier. It is noted that to convert from osy to gsm, multiply osy by 33.91. Particularly, the nonwoven sheet material usable in the temporary partition curtain may be in the ranges of about 10 gsm to about 100 gsm (0.29 osy to about 2.95 osy). The basis weight of the nonwoven sheet material may be lower than 10 gsm; however the nonwoven sheet material may not have the desired durability or may not substantially prevent particles from passing through the nonwoven sheet material. The basis weight of the nonwoven sheet material may be higher than 100 gsm; however, this will increase the cost of the nonwoven sheet material, make the nonwoven sheet material more difficult to install, with little improvement in the particle penetration property of the nonwoven sheet material. In addition, higher basis weight materials may result in a reduction of the air permeability of the nonwoven sheet material. In one particular embodiment, the nonwoven sheet material has a basis weight of between about 10 gsm and 34 gsm. In a further embodiment, the nonwoven sheet material has a basis weight between about 10 gsm and 18 gsm. Nonwoven webs in this basis weight range provide a good balance of properties and cost.

The nonwoven sheet material should also be air permeable. This will allow air to be exchanged between the first area and the second area. In addition, by having a nonwoven sheet material which is air permeable, an air pressure differential may be avoided between the first and second areas. When an air pressure differential between the first and second areas occurs, if the nonwoven sheet material was not air permeable, the temporary partition curtain could be caused to move towards the area of lower pressure. By providing a temporary partition curtain which is air permeable, pressure differentials between the first and second areas may be reduced, which in turn could avoid the problem of the temporary partition curtain from moving in the place of use. Generally, the nonwoven sheet material used in the temporary partition curtain has an air permeability of at least about 10 ft³/min/ft² as measured by ISO-9237 (1995) at a test pressure of 125 Pa. Typically, the nonwoven sheet materials may have an air permeability between about 25 ft³/min/ft² and about 600 ft³/min/ft² as measured by ISO-9237 (1995) at a test pressure of 125 Pa. In one particular embodiment of the present invention, the nonwoven sheet material used in the temporary partition curtain has an air permeability between about 200 ft³/min/ft² and about 400 ft³/min/ft² as measured by ISO-9237 (1995) at a test pressure of 125 Pa. The ISO-9237 (1995) test is described in more detail below.

In addition, the nonwoven sheet material substantially prevents particles from passing through the first side to the second side of the nonwoven sheet material. The ability of a nonwoven sheet material to substantially prevent particles from passing through the nonwoven sheet material may be expressed in terms of efficiency. As is stated above, “substantially prevents particles from passing through the nonwoven web” is intended to mean that a majority of the particles which are generated or present in the first area are maintained in the first area. To determine if a nonwoven web material meets this requirement, a Gravimetric Fractional Efficiency Test, which is described in more detail below, may be used. The nonwoven sheet material should have a filtration Gravimetric Fractional Efficiency of at least 80% for particle having a particle size larger than about 1 micron. More particularly, the Gravimetric Fractional Efficiency for particles having a particle size greater than about 1 micron is at least 90%.

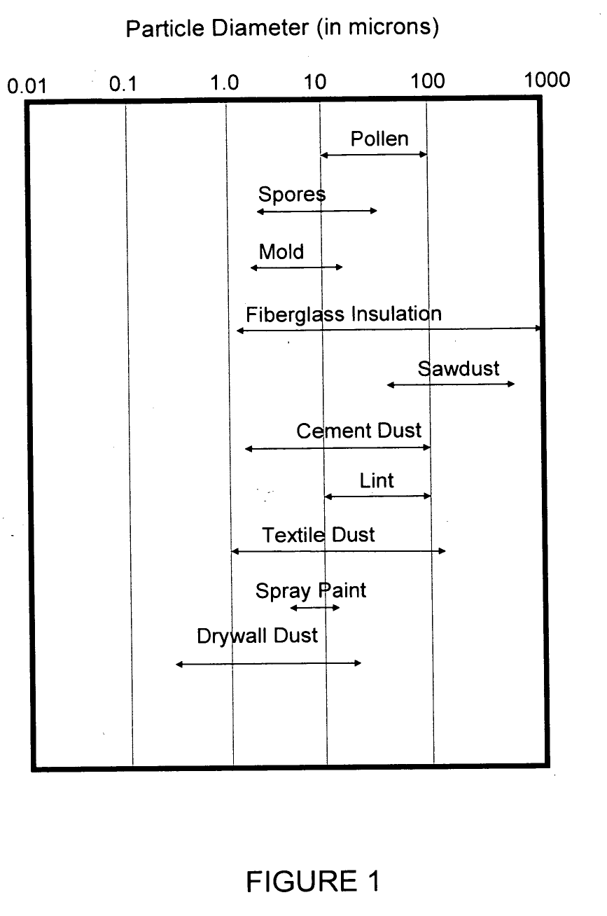

Typically, airborne particulates encountered during construction may include pollen, spores, mold, fibers including fiberglass insulation, asbestos and other similar fibers, sawdust, cement dust, lint, textile dust, spray paint, lead particles, and drywall dust. FIG. 1 shows particle size ranges for some of these materials. As can be seen, most of these materials have typical particle sizes in excess of about 1 micron, with the exception of drywall dust, which particle sizes in excess of about 0.4 microns. It is pointed out; however, that only about 10 percent of the drywall dust has an average particle size less than about 1.0 microns. About 90 percent of drywall dust has an average particle size between 1 and about 40 microns.

The fibers or filaments of the nonwoven sheet material may be prepared from a variety of materials including thermoplastic polymers. The exact selection of the thermoplastic polymer depends upon, for example, fiber cost and the desired properties, e.g., liquid resistance, air permeability or liquid wicking, or the finished drape. For example, suitable thermoplastic resins may include, but are not limited to, synthetic resins such as those derived from polyolefins, polyesters, polyamides, polyacrylics, etc., alone or in combination with one another. Monocomponent and multicomponent, or conjugate, synthetic fibers may be used alone or in combination with other fibers. Other suitable fibers include natural fibers such as cotton, linen, jute, hemp, cotton, wool, wood pulp, etc. Similarly, regenerated cellulosic fibers such as viscose rayon and cuprammonium rayon, or modified cellulosic fibers, such as cellulose acetate, may likewise be used. Blends of one or more of the above fibers may also be used if so desired. From the standpoint of cost and effectiveness, polyolefins, in particular, polypropylene is a suitable material to prepare the nonwoven sheet material.

In addition, the fibers and/or filaments of the nonwoven sheet material may have thermoplastic elastomers blended therein. In addition, the polymer components may contain additives for enhancing the crimpability and/or lowering the bonding temperature of the fibers, and enhancing the abrasion resistance, strength, particulate capturing ability and softness of the resulting nonwoven sheet material. For example, the low melting polymer component may contain about 5 percent by weight to about 20 percent by weight of a thermoplastic elastomer such as an ABA block copolymer of styrene, ethylenebutylene and styrene. Such copolymers are commercially available and some of which are identified in U.S. Pat. No. 4,663,220 to Wisneski et al. An example of highly suitable elastomeric block copolymers is KRATON G-2740. Another group of suitable additive polymers is ethylene alkyl acrylate copolymers, such as ethylene butyl acetate, ethylene methyl acrylate and ethylene ethyl acrylate, and the suitable amount to produce the desired properties is from about 2 weight percent to about 50 weight percent, based on the total weight of the low melting polymer component. Yet other suitable additive polymers include polybutylene copolymers and ethylene-propylene copolymers.

In addition, other additives may be added to the polymers used to prepare the nonwoven sheet materials. The additional additives may include fillers, telomers, ferroelectric materials, odor control agents and other similar materials which may impart desirable properties to the nonwoven sheet material.

Telomers includes a polymer having one or more functional groups located at the chain ends of the polymer. Telomers are also referred to as telechelic polymers and are known in the art. Telomers generally include polymers having one or more functional groups located at the chain ends of the polymer. Various telomers and methods of making the same are described in Encyclopedia of Polymer Science and Engineering, vol. 16, pg. 494-554 (1989). As particular examples, polyolefin-anhydride telomers (a polyolefin polymer having one or more anhydride end groups) suitable for use with the present invention are commercially available from ExxonMobil Chemical Company of Houston, Tex. under the tradename EXXELOR and from Chemtura Corporation under the tradename POLYBOND. The telomer can be a homopolymer, copolymer, terpolymer or other composition. However, with copolymers or other polymers with a plurality of repeat units, the terminal or end functional groups of telomers do not have the same chemical functionality as the repeat units. Telomers can have either one or a plurality of functional end groups and the average number of functional end groups for a given telomer will vary with the method of formation, degree of chain branching and other factors known to those skilled in the art.

Ferroelectric materials generally include a crystalline material that possesses a spontaneous polarization which may be reoriented by the application of an external electric field. Ferroelectric materials include any phase or combination of phases exhibiting a spontaneous polarization, the magnitude and orientation of which can be altered as a function of temperature and externally applied electric fields. The term also is meant to include a single ferroelectric material and mixtures of two or more ferroelectric materials of the same class or of different classes. The term further includes a “doped” ferroelectric material, i.e., a ferroelectric material that contains minor amounts of elemental constituents, as well as solid solutions of such constituents, in the host ferroelectric material. Ferroelectric materials exhibit a “Curie point” or “Curie temperature” which refers to a critical temperature above which the spontaneous polarization vanishes. The Curie temperature often is indicated herein as “T_{c}”.

The nonwoven sheet material may also be electret treated. “Electret” refers to a treatment that imparts charges to a dielectric material, for example an olefin polymer. The charge includes layers of positive or negative charges trapped at or near the surface of the polymer, or charge clouds stored in the bulk of the polymer. The charge also includes polarization charges which are frozen in alignment of the dipoles of the molecules. Methods of subjecting a material to electreting are known by those skilled in the art. These methods include, for example, thermal, liquid-contact, electron beam and corona discharge methods. An exemplary technique of electret treatment is described in U.S. Pat. No. 5,401,446 to Tsai et al. assigned to the University of Tennessee Research Corporation, the entire contents of which are hereby incorporated herein by reference. Tsai describes a process whereby a web or film is sequentially subjected to a series of electric fields such that adjacent electric fields have substantially opposite polarities with respect to each other. Thus, one side of the web or film is initially subjected to a positive charge while the other side of the web or film is initially subjected to a negative charge. Then, the first side of the web or film is subjected to a negative charge and the other side of the web or film is subjected to a positive charge. Such webs are produced with a relatively high charge density. The process maybe carried out by passing the web through a plurality of dispersed non-arcing electric fields like, for example, between a charging wire or bar and a charged roller at a certain gap, where the field and gap may be varied over a range depending on the charge desired in the web. The web may be charged at a range of about −30 kVDC/cm to 30 kVDC/cm or more particularly −10 kVDC/cm to 25 kVDC/cm and still more particularly −5 kVDC/cm to about 25 kVDC/cm. The gap may be about 0.25 inch (6.5 mm) to about 2 inches (51 mm) or more particularly about 0.5 to 1.5 inches (13 to 38 mm) or still more particularly about an inch (25.4 mm).

Other methods of electret treatment are known in the art such as that described in U.S. Pat. No. 4,215,682 to Kubik et al, U.S. Pat. No. 4,375,718 to Wadsworth, U.S. Pat. No. 4,592,815 to Nakao and U.S. Pat. No. 4,874,659 to Ando. A method of inline electret treating a nonwoven web is described in U.S. Pat. No. 6,365,088 to Knight et al., the entire contents of which are hereby incorporated herein by reference.

A process of forming an electret nonwoven web using a DC corona discharge is disclosed in U.S. Pat. No. 6,365,088, the entire content of which is also hereby incorporated herein by reference. Telomers and ferroelectric materials may be included in the polymers to improve the nonwoven sheet material ability to hold an electret charge, as is disclosed in U.S. Pat. No. 6,573,205, the entire content of which is hereby incorporated herein by reference.

Odor control agents include any substance known to reduce or mask odors. Examples of such materials include but are not limited to odor absorbents, activated carbon fibers and particles, talc, baking soda, chelating agents, zeolites, perfumes or other odor-masking agents, cyclodextrin compounds, oxidizers, and the like. Odor control agents may be added to the polymer melt used to produce the fibers or may be coated or otherwise placed on the surface of the fibers. Odor control agents may reduce or prevent odor from escaping the first area.

The nonwoven sheet materials used to prepare the temporary partition curtain may be bonded or unbonded. Suitable bonding includes thermal point bonding, ultrasonic bonding, thru-air bonding and other known nonwoven web bonding techniques. Thermal point bonding involves passing materials (fibers, webs, films, etc.) to be bonded, for example, between a heated pattern roll and an anvil roll, a pattern roll and a flat anvil roll or two patterned rolls. The pattern roll is usually patterned in some way so that the entire fabric is not bonded across its entire surface. As a result, various patterns for calender rolls have been developed for functional as well as aesthetic reasons. Typically, the percent bonding area varies from around 10 percent to around 30 percent of the area of the fabric laminate. As is well known in the art, thermal point bonding holds the laminate layers together and imparts integrity to each individual layer by bonding filaments and/or fibers within each layer.

Of the nonwoven sheet materials described herein, nonwoven sheet materials prepared from spunbond nonwoven webs offer the best balance of cost and performance. The spunbond nonwoven webs may be a single web or a laminate of two or more webs. One particular spunbond laminate, a Spunbond/meltblown/spunbond (SMS), is especially suitable as the sheet material for the temporary partition curtain. Spunbond/meltblown/spunbond (SMS) laminates are known in the art and are described in greater detail in and U.S. Pat. No. 4,041,203 to Brock et al., U.S. Pat. No. 5,169,706 to Collier and in U.S. Pat. No. 5,188,885 to Timmons et al., the entire contents of which are hereby incorporated herein by reference. Generally, an SMS laminate is formed from one or more fibrous materials and includes a spunbonded layer, a meltblown layer, and a spunbonded layer formed from one or more thermoplastic polymers. SMS laminates may include other fibrous materials including natural fibers.

Desirably, the sheet material is formed from a single layer of a bonded SMS nonwoven material. However, in the case of a sheet material having multiple layers, having one or more layers of the sheet material be a SMS layer provides very desirable properties to the nonwoven sheet material and, hence, the temporary partition curtain. When multiple discrete layers are combined to form the sheet material, the layers are generally positioned in a juxtaposed or surface-to-surface relationship and all or a portion of the layers may be bound to adjacent layers.

The nonwoven sheet material used in the system of the present invention may include at least one SMS laminate that is electret treated. In this regard, the SMS laminate may include at least one layer of a ferroelectric material and, more desirably, at least one layer that includes a ferroelectric material and further includes a telomer. More desirably, the material may comprise a SMS laminate that includes a ferroelectric material and a telomer in each layer. Specifically, in one desirable embodiment, the two spunbonded layers and the interior meltblown layer each include a ferroelectric material and a telomer. Desirably, the meltblown layer in the SMS laminate is an electret meltblown layer. The meltblown layer has a basis weight selected to achieve an overall breathability of the material at an acceptable level.

Electret treatment of the SMS laminate further increases filtration efficiency by drawing particles to be filtered toward the fibers of the filter by virtue of their electrical charge. Electret treatment can be carried out by a number of different techniques. The spunbonded layers and meltblown layer of the SMS laminate are desirably bonded, more desirably thermally point bonded. Generally, the layers are bonded after the layers are formed and before the laminate is further processed. Thermal point bonding involves passing a fabric or web of fibers to be bonded, for example the SMS laminate, between, for example a heated pattern roll and an anvil roll. The pattern roll is usually, though not always, patterned in some way so that the entire fabric is not bonded across its entire surface.

These bonding rolls can include a pattern roll and anvil roll in combination or two pattern rolls. As a result, various patterns for rolls have been developed for functional as well as aesthetic reasons. One example of a pattern known as a “wire weave” pattern is illustrated in FIG. 3 of U.S. Pat. No. 5,964,742 to McCormack et al. The wire weave pattern looks like a window screen and has about an 18 percent bond area. Other common patterns include a diamond pattern with repeating and slightly offset diamonds with about a 16% bond area. Typically, the percent bonding area varies from around 10% to around 30% of the area of the fabric laminate web. As is well known in the art, the spot bonding holds the laminate layers together as well as imparts integrity to each individual layer by bonding filaments and/or fibers within each layer.

The nonwoven sheet material may further be treated with a treating agent to render the sheet material hydrophobic or hydrophilic. Depending on the fiber or filaments used to prepare the nonwoven sheet material, the nonwoven fabric may naturally be hydrophobic or hydrophilic. For example, nonwoven sheet materials prepared from polyolefins are typically hydrophobic in nature. Conventional hydrophobic treating agents or conventional hydrophilic treating agents known to those skilled in the art may be used. Depending on use of the temporary partition curtain, it may be desirable to have a temporary partition curtain which is hydrophilic or hydrophobic. For example, in construction jobs which include painting, it may be desirable to have the temporary partition curtain to be wettable, or hydrophilic to prevent paint which comes into contact with the temporary partition curtain from flowing to the floor.

The temporary partition curtain will generally be provided to the user in the form of a roll. Typically, the temporary partition curtain will have an overall width of about 10 feet, and an overall length of about 25 feet, 50 feet or more. Different widths may be provided, for example 8 feet-9 feet widths; however, an overall width of about 10 foot wide may provide other advantages which are discussed below. Generally, a 10 foot width will be usable in most homes and business in areas where the ceiling is less than 10 feet high. In addition, the temporary partition curtain material may be cut down to the desired size or two or more widths may be joined to form a larger width material. By having a 10 foot width for the temporary partition curtain, when used in areas with 8 or 9 foot ceilings, the excess material can be draped over the floor in the area or may be folded or rolled next to the hanging portion of the curtain. This will provide protection to the floor in this area and could also serve to capture any particulates which may fall towards the floor or do not attach to the nonwoven sheet material.

To hang the temporary partition curtain, various methods may be used. Masking or painter's tape may be used to tape the temporary partition curtain to the ceiling in the work area. In addition, partition mounts which may include telescoping poles, such as those described in U.S. Pat. No. 5,924,469 to Whittemore, which is hereby incorporated by reference in its entirety. One additional advantage, which may be provided by the nonwoven sheet material is that some nonwovens, including spunbond/meltblown/spunbond nonwoven webs, will engage hook materials typically used in hook and loop fasteners. As is noted in the Whittemore patent, a loop or hook material maybe attached to the curtain to assist in holding the curtain in place during use. With the nonwoven sheet material, including the spunbond/meltblown/spunbond nonwoven web, a hook material may be placed on the end of the pole and the hook will engage the nonwoven sheet material, holding the temporary partition curtain in place without the need to include a separate loop material on the temporary partition curtain.

In addition, to assist in keeping the temporary partition curtain in place during use, weights, magnets or other similar items may be attached to or otherwise placed within or on the surface of the temporary partition curtain.

Another advantage of the temporary partition curtain of the present invention is that less raw material is need to prepare the nonwoven sheet material than is necessary to prepare a film of the raw material having a similar basis weight. As a result, the nonwoven sheet material, used in the temporary partition curtain may be more earth friendly than a film material.

Other uses for the temporary partition curtain include placing the material in doorways and windows to help prevent particulates for entering or exiting rooms in a building. Further uses of the temporary partition curtain will be apparent to those skilled in the art.

Air Permeability Test

The Air Permeability of the nonwoven sheet materials are tested using a Textest FX 3300 apparatus, available from TEXTEST AG, Schwerzenbach, Switzerland. The nonwoven material test samples should be clean and free of defects. The sample areas are visually analyzed to determine that the samples were also free from printing and perforation lines. The sample specimens were cut into square shapes approximately 6 inches (15.2 cm) on each side. Ten individual specimens were analyzed, and the results were averaged.

Each specimen was cut and placed so that the specimen extended beyond the clamping area of the testing apparatus. The nonwoven sheet materials to be tested were obtained from areas of the sample that were free of folds, crimp lines, perforations, wrinkles, and/or any distortions that make them abnormal from the rest of the test material. The tests were conducted in a standard laboratory atmosphere of 23±1° C. (73.4±1.8° F.) and 50±2% humidity. The testing apparatus is turned on and allowed to warm up for at least 5 minutes before testing any samples. The instrument is calibrated based on the manufacturer's guidelines before the nonwoven sheet material is analyzed. A rubber plate or cover is removed from the testing apparatus and the NULL RESET button is pressed to reset pressure sensors to zero. Before testing, and if necessary between samples or specimens, a dust filter screen of the testing apparatus can be cleaned, following the manufacturer's instructions. The following specifications are selected for data collection: (a) Unit of measure: cubic feet per minute (cfm) 1 cfm=0.028 m³/min; (b) test pressure: 250 Pascal (Pa; water column 1 inch/2.54 cm); and (c) test head: 38 square centimeters (cm²). Since test results obtained with different size test heads may not always comparable, samples to be compared should be tested with the same size test head.

The NULL RESET button is pressed prior to every series of tests, or when a red light is displayed on the testing apparatus. The test head must be open (no specimen in place) and the vacuum pump must be at a complete stop before the NULL RESET button is pressed.

The following procedure was followed to test the Air Permeability of each test specimen:
1. Place the specimen over the lower test head.
2. Start the test by manually pressing down on the clamping lever until the vacuum pump automatically starts.
3. Stabilize the Range Indicator light in the green or yellow area using the RANGE knob. The measuring range may be changed while the vacuum pump is running only for testing apparatuses built in 1992 or later.
4. After the digital display stabilizes, the air permeability of the specimen will be displayed in the desired unit of measure. Record the value. Press down on the clamping lever to release the specimen.
5. Repeat the procedure for all specimens.
6. In the case of bulky specimens that may permit lateral air flow of significant magnitude, each specimen should be tested twice. Prior to the second test, the specimen should be covered with the rubber plate provided by the manufacturer. The rubber plate will be located between the specimen and the upper test head. The plate should be left in place for the second test. The air permeability of the material is calculated as the difference in the results between the two tests.
7. When testing is complete, cover the lower test head with the supplied rubber plate.
8. Calculate an average air permeability value from the permeabilities of the 10 individual specimens. A standard deviation may also be calculated, if desired.

Gravimetric Fraction Efficiency Test

Fractional efficiency test indicates filtration efficiency testing based on discrete particle sizes in very low concentration. This type of testing provides a good comparison for filters without any consideration for the application they are used for. The gravimetric fractional efficiency test provides a realistic efficiency measurement for filters used in high concentration situations. The concentration of dry wall powder or other dust commonly found in construction projects are generally high that can be seen with naked eye. This test provides the type of data which mimics in situ situation when the particles cause the loading of the filter and initial efficiency can not exist for more than a few seconds.

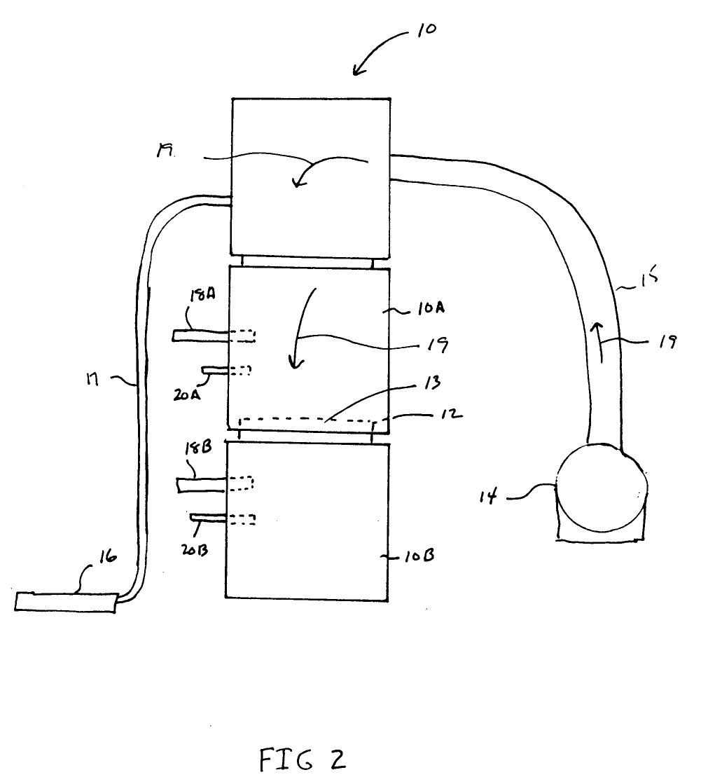

The equipment used for the Gravimetric Fraction efficiency test is represented in diagram of FIG. 2. The test equipment includes a vertical duct system 10, a filter holder 12 positioned within the duct system 10 in a horizontal orientation, a blower 14, an ASHRAE dust feeder 16, sensors for measuring pressure drop 18A and 18B, and two particle counters 20A and 20B. The air entering the blower 14 is filtered through a HEPA filter (not shown) to prevent outside particle from entering the duct system 10. The dust from the ASHRAE dust feeder 16 and the air from the blower 14 enter the vertical duct system 10 in a section of the vertical duct 10A which is above the filter holder 12. The dust is transported from the dust feeder 16 to the duct system 10 via a hose 17 and the air from the blower 16 is transferred to the duct system 10 through a hose type structure 15; both the hose 17 and hose type structure 15 are connected to the duct system 10. Generally, air flows through the duct system and hose type structure in the direction shown by the arrows 19. A first particle counter 20A and a first pressure sensor 18A are placed above the test material, in the region of the duct system 10A which is above the test material or in the area in which the air and dust are fed to the duct system 10. A second particle counter 20B and a second pressure sensor 18B are placed down stream or below the test material 13. Air and dust is vented from the section of the duct system 10B which is below the test material. The particle counters 20A and 20B and pressure sensors 18A and 18B are connected to a data collection means, such as a computer. The system is run in accordance with the following test procedure.
A: Place the flat sheet material to be tested in a 12×12″ holder and place the holder and material in the test duct.
B: Start the blower and set the flow to the desired flow rate.
C: Measure the pressure drop cross the flat media at the given flow.
D: Weight an amount of dry wall mud powder and then place in the tray of ASHRAE Dust Feeder. Distribution of the dust should take place for about 10-20 minutes of to create the realistic situation experienced with the sample in the field.
E: Start the particle counters and sample particle concentration up and down stream to calculate efficiency of the filter tested. Take samples every minute for total of ten minutes. Monitor for the decrease in the flow rate and keep the flow constant by increasing the rpm of the blower.
F: After 10 minutes remove the test sample from the test duct.
G: Set the flow to the desired flow rate for the empty duct.
H: Re-start the dust feeder and take 2 samples to use for correlation of the particle counters.
G: Enter the data in computer and calculate efficiencies of the sample for 1-10 minutes in 2 minutes intervals.

### EXAMPLE

A 0.4 osy white spunbond/meltblown/spunbond available from Kimberly-Clark Global Sales, LLC, having offices in Roswell, Ga. was tested from permeability and gravimetric fractional efficiency in accordance with the test procedures described above. The permeability, as measured, is shown in TABLE 1 and the gravimetric fractional efficiency is shown in TABLE 2. For the Gravimetric Fractional Efficiency Test dry wall mud mix was tested. The blower was set at a rate of 5 feet per minute. The dry wall mud test dust had a particle size distribution in accordance with TABLE 3. 5 grams of the dry wall mud dust was placed in the ASHRAE duct feeder.

TABLE 1

| | Air Permeability |
|---|---|
| Sample | cfm/ft² |
| 1 | 337.00 |
| 2 | 320.00 |
| 3 | 315.00 |
| 4 | 367.00 |
| 5 | 343.00 |
| AVG | 336.40 |
| STD | 20.66 |

TABLE 2

| | Status (Minutes) | | | | |
|---|---|---|---|---|---|
| | 1 | 3 | 5 | 7 | 10 |
| Size Range (μm) | Gravimetric Fractional Efficiency (%) | | | | |
| 0.3-0.5 | 46.9 | 51.6 | 57.4 | 66.3 | 72.6 |
| 0.5-0.7 | 58.3 | 62.3 | 69.5 | 77.8 | 82.9 |
| 0.7-1.0 | 66.9 | 70.8 | 77.3 | 85.3 | 91.3 |
| 1.0-2.0 | 76.3 | 79.3 | 86.6 | 92.6 | 98.5 |
| 2.0-3.0 | 83.2 | 86.8 | 91.3 | 96.8 | 99.6 |
| 3.0-5.0 | 87.9 | 91.1 | 95 | 99 | 100.0 |
| >5.0 | 92.6 | 95.3 | 98.8 | 99.4 | 100.0 |

TABLE 3

| Size Range (μm) | % particles |
|---|---|
| 0.3-1.0 | 9.5% |
| 1.0-2.0 | 23.1% |
| 2.0-3.0 | 17.0% |
| 3.0-5.0 | 21.6% |
| >50 | 28.8% |

As can be seen from the forgoing example, the nonwoven sheet material has a fairly light basis weight provides an effective air permeability and particulate capturing properties that make the nonwoven sheet material an effective dust barrier.

While the present subject matter has been described in detail with respect to specific embodiments thereof, it will be appreciated that those skilled in the art, upon attaining an understanding of the foregoing, may readily adapt the present technology for alterations to, variations of, and equivalents to such embodiments. Accordingly, the scope of the present disclosure is by way of example rather than by way of limitation, and the subject disclosure does not preclude inclusion of such modifications, variations, and/or additions to the present subject matter as would be readily apparent to one of ordinary skill in the art.

What is claimed is:

1. A temporary partition curtain for isolating a first area from a second area, said temporary partition curtain comprising
a nonwoven sheet material having a first side and a second side, said nonwoven sheet material has an air permeability of at least about 10 ft³/min/ft² as measured by ISO-9237 (1995) at a test pressure of 125 Pa and the nonwoven sheet material substantially prevents airborne particulates from passing through the nonwoven sheet material from the first side to the second side;
wherein the nonwoven sheet material, when placed between the first area and the second area, substantially prevents airborne particulates present in the first area from migrating to the second area.

2. The temporary partition curtain according to claim 1, wherein the nonwoven sheet material has an air permeability of between about 25 ft³/min/ft² and about 600 ft³/min/ft² as measured by ISO-9237 (1995) at a test pressure of 125 Pa.

3. The temporary partition curtain according to claim 2, wherein the nonwoven sheet material has an air permeability of between about 200 ft³/min/ft² and about 400 ft³/min-ft² as measured by ISO-9237 (1995) at a test-pressure of 125 Pa.

4. The temporary partition curtain according to claim 1, wherein the nonwoven sheet material comprises a spunbond nonwoven web, a meltblown nonwoven web, a bonded carded nonwoven web, or a laminate thereof.

5. The temporary partition curtain according to claim 4, wherein the nonwoven sheet material comprises a laminate of spunbond with an apertured film or a laminate of a spunbond nonwoven web with a meltblown nonwoven web.

6. The temporary partition curtain according to claim 5, wherein the nonwoven sheet material comprises a spunbond/meltblown/spunbond (SMS) sheet material.

7. The temporary partition curtain according to claim 6, wherein said nonwoven sheet material comprises a spunbond/meltblown/spunbond (SMS) material having a basis weight of between about 10 gsm to about 34 gsm.

8. The temporary partition curtain according to claim 1, wherein the nonwoven web has a basis weight of about 10 gsm to about 100 gsm.

9. The temporary partition curtain according to claim 1, wherein the nonwoven sheet material comprises a spunbond/meltblown/spunbond (SMS) material, and the nonwoven sheet material has an air permeability of between about 200 ft³/min/ft² and about 400 ft³/min/ft² as measured by ISO-9237 (1995) at a test pressure of 125 Pa.

10. The temporary partition curtain according to claim 9, wherein said nonwoven sheet material comprises a spunbond/meltblown/spunbond (SMS) material having a basis weight of between about 10 gsm to about 18 gsm.

11. The temporary partition curtain according to claim 1, wherein the nonwoven sheet material is electret treated.

12. The temporary partition curtain according to claim 1, wherein the nonwoven sheet material further comprises an odor control agent.

13. The temporary partition curtain according to claim 1, wherein the nonwoven sheet material has a gravimetric fractional efficiency for particle larger than 1 micron of at least 80%.

14. The temporary partition curtain according to claim 1, wherein the nonwoven sheet material has a gravimetric fractional efficiency for particle larger than 1 micron of at least 90%.

15. A method of isolating a first area from a second area to substantially prevent particles present in the first area from migrating from the first area to the second area, said method comprising
providing a nonwoven sheet material having a first side and a second side, said nonwoven sheet material has an air permeability of at least about 10 ft³/min/ft² as measured by ISO-9237 (1995) at a test pressure of 125 Pa and the nonwoven sheet material substantially prevents particulates from passing through the nonwoven sheet material from the first side to the second side;
placing the nonwoven sheet material between the first area and the second area; and
sealing the first area from the second area using the nonwoven sheet material.

16. The method according to claim 13, wherein the nonwoven sheet material has an air permeability of between about 200 ft³/min/ft² and about 400 ft³/min/ft² as measured by ISO-9237 (1995) at a test pressure of 125 Pa.

17. The method according to claim 16, wherein the nonwoven sheet material comprises a spunbond nonwoven web, a meltblown nonwoven web, a bonded carded nonwoven web, or a laminate thereof.

18. The method according to claim 17, wherein the nonwoven sheet material comprises a laminate of spunbond with an apertured film or a laminate of a spunbond nonwoven web with a meltblown nonwoven web.

19. The method according to claim 18, wherein the nonwoven sheet material comprises a spunbond/meltblown/spunbond (SMS) sheet material.

20. The method according to claim 19, wherein said nonwoven sheet material comprises a spunbond/meltblown/spunbond (SMS) material having a basis weight of between about 10 gsm to about 34 gsm.
